(19) United States
(12) Patent Application Publication
(10) Pub. No.: US 2023/0160708 A1
(43) Pub. Date: May 25, 2023

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Yukiya SUGIYAMA, Kasugai-shi (JP); Koichi SUZUKI, Miyoshi-shi (JP); Tatsuya TSUJIMOTO, Toyota-shi (JP); Akimitsu UMEKAWA, Kuwana-shi (JP); Shintaro MATSUTANI, Kariya-shi (JP); Ryouta TSUKAHARA, Nagoya-shi (JP)

(21) Appl. No.: 17/936,883

(22) Filed: Sep. 30, 2022

(30) Foreign Application Priority Data
Nov. 22, 2021 (JP) 2021-189445

(51) Int. Cl. G01C 21/34; B60W 20/20

(52) U.S. Cl. CPC G01C 21/3469; B60W 20/20

(57) ABSTRACT

In an information processing device of this disclosure, a control unit acquires an operation history of an internal combustion engine vehicle for a first period. On the assumption that a first BEV is operated according to an operation schedule shown by the acquired operation history, the control unit determines whether the battery needs charging during travel of the first BEV. When it is determined that the battery needs charging during travel of the first BEV, the control unit generates first information including information about a timing of charging and a charging place and outputs the generated first information through a first terminal.

### CROSS-REFERENCE TO RELATED APPLICATION

This application claims priority to Japanese Patent Application No. 2021-189445 filed on Nov. 22, 2021, incorporated herein by reference in its entirety.

### BACKGROUND

### 1. Technical Field

This disclosure relates to an information processing device and an information processing method.

### 2. Description of Related Art

There is a known technology that acquires conditions under which a user's vehicle has actually traveled, and estimates an energy consumption of a vehicle being compared that differs from the user's vehicle in energy consumption characteristics and/or an energy source on the assumption that the vehicle being compared travels under those conditions (e.g., see Japanese Unexamined Patent Application Publication No. 2010-271749 (JP 2010-271749 A)).

### SUMMARY

An object of this disclosure is to provide a technology that can contribute to encouraging users of internal combustion engine vehicles to switch to battery electric vehicles (BEVs).

This disclosure can be regarded as an information processing device. The information processing device in that case may include a control unit that executes, for example: acquiring an operation history of an internal combustion engine vehicle for a first period; generating first information about a timing of charging a battery of a first BEV on the assumption that the first BEV is operated according to an operation schedule shown by the operation history; and outputting the first information through a first terminal.

This disclosure can also be regarded as an information processing method. The information processing method in that case may be a method in which a computer executes, for example: acquiring an operation history of an internal combustion engine vehicle for a first period; generating first information about a timing of charging a battery of a first BEV on the assumption that the first BEV is operated in accordance with an operation schedule shown by the operation history; and outputting the first information through a first terminal.

This disclosure can also be regarded as an information processing program that causes a computer to execute the information processing method described above, or as a non-transitory storage medium that stores this information processing program.

According to this disclosure, a technology that can contribute to encouraging users of internal combustion engine vehicles to switch to BEVs can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing an overview of a charging simulation system to which an information processing device according to this disclosure is applied;

FIG. 2 is a diagram showing one example of the hardware configuration of each of an on-board terminal, a user terminal, and a server device that are included in the charging simulation system;

FIG. 3 is a block diagram showing one example of the functional configuration of the server device in an embodiment;

FIG. 4 is a chart schematically showing one example of a virtual schedule in the embodiment;

FIG. 5 is a first graph showing changes over time in a remaining battery charge on the assumption that a first BEV travels according to the virtual schedule;

FIG. 6 is a second graph showing changes over time in the remaining battery charge on the assumption that the first BEV travels according to the virtual schedule;

FIG. 7 is a first chart for describing a method of determining a charging place in the embodiment;

FIG. 8 is a second chart for describing a method of determining a charging place in the embodiment;

FIG. 9 is a flowchart showing a processing routine executed in the server device in the embodiment;

FIG. 10 is a chart for describing a method of determining a charging place in Modified Example 1;

FIG. 11 is a chart for describing a method of determining a charging place in Modified Example 2;

FIG. 12 is a chart for describing a method of determining a charging place in Modified Example 4; and

FIG. 13 is a flowchart showing a processing routine executed in the server device in Modified Example 5.

### DETAILED DESCRIPTION OF EMBODIMENTS

Recently, there is a budding movement to promote the widespread use of BEVs. In response, users of internal combustion engine vehicles are expected to consider switching to BEVs. However, users of internal combustion engine vehicles may hesitate to switch to BEVs because they cannot predict when to charge the battery of a BEV.

As a solution, an information processing device according to this disclosure presents a user of an internal combustion engine vehicle with information (first information) about a timing of charging the battery on the assumption that a first BEV is operated according to an operation schedule of an internal combustion engine vehicle during a first period. Specifically, in the information processing device according to this disclosure, a control unit acquires an operation history of the internal combustion engine vehicle for the first period. The first period is, for example, one day, one week, or a period specified by the user of the internal combustion engine vehicle. The operation history is data in which driving states of the internal combustion engine vehicle during the first period and positions of the internal combustion engine vehicle during the first period are recorded in chronological order so as to be associated with each other. This data shows an actual operation schedule of the internal combustion engine vehicle during the first period (e.g., a parking start time, parking end time, parking position, travel start time, travel start position, travel end time, travel end position, travel route, and traveling positions at respective times of day).

The control unit generates first information about a timing of charging the battery of the first BEV on the assumption that the first BEV is operated according to the operation schedule shown by the operation history of the internal combustion engine vehicle (hereinafter also referred to as a “first operation schedule”). The first BEV here is, for example, a BEV of which the size class is the same as or similar to that of the internal combustion engine vehicle, a BEV of which the price is similar to that of the internal combustion engine vehicle, or a BEV manufactured by the same manufacturer as the internal combustion engine vehicle. The first BEV may also be a BEV specified by the user of the internal combustion engine vehicle (e.g., a BEV to which the user is considering switching from the internal combustion engine vehicle). The timing of charging here is a timing when the battery needs charging during travel of the first BEV on the assumption that the first BEV is operated according to the first operation schedule.

The control unit outputs the generated first information through a first terminal. The first terminal is, for example, an on-board terminal installed in the internal combustion engine vehicle or a user terminal used by the user of the internal combustion engine vehicle. Here, when the information processing device according to this disclosure is a server device on a network, the control unit may transmit, to the first terminal, a command for making the first terminal output the first information. Further, the control unit may have the first information output (displayed) through a Web browser of the first terminal.

According to this disclosure, the user of the internal combustion engine vehicle can receive provision of the first information through the first terminal. Thus, before switching to the first BEV, the user of the internal combustion engine vehicle can ascertain the timing of charging of the first BEV on the assumption that the first BEV is operated according to the first operation schedule. As a result, when using the first BEV in the same manner as the internal combustion engine vehicle during the first period, the user of the internal combustion engine vehicle can predict when to charge the battery of the first BEV. Thus, hesitation in switching from the internal combustion engine vehicle to the first BEV can also be eliminated.

Here, the control unit of the information processing device according to this disclosure may calculate a battery consumption amount on the assumption that the first BEV is operated according to the first operation schedule. The control unit may calculate a remaining battery charge based on the calculated battery consumption amount. The control unit may determine the timing of charging based on the calculated remaining battery charge. For example, the control unit may determine, as the timing of charging, a timing when the remaining battery charge decreases to a threshold value (e.g., a remaining battery charge of about 10% to 20%). The control unit may generate the first information based on the determined timing of charging. Thus, the timing of charging the battery on the assumption that the first BEV is operated according to the first operation schedule can be estimated. The battery consumption amount may be calculated based on factors such as the gradients of roads on which the internal combustion engine vehicle has traveled during the first period, travel speeds at which the internal combustion engine vehicle has traveled during the first period, and the rates of acceleration and deceleration that the internal combustion engine vehicle has experienced while traveling during the first period. As another method, the battery consumption amount may be calculated on the assumption that the first BEV travels under conditions under which the power consumption rate is highest.

The information processing device according to this disclosure may estimate the remaining battery charge taking into account that the battery of the first BEV is charged in a storage place, such as a parking space at the home of the user. In this case, in the information processing device according to this disclosure, the control unit may specify a first length of time for which the first BEV is parked in the storage place on the assumption that the first BEV is operated according to the first operation schedule. The control unit may calculate a first charging amount of the battery on the assumption that the first length of time is a length of a charging time of the battery. The control unit may calculate the remaining battery charge based on the battery consumption amount and the first charging amount. For example, for a period in the first period during which the first BEV travels, the control unit may subtract the battery consumption amount from the remaining battery charge. For a period in the first period during which the first BEV is parked in the storage place, the control unit may add the first charging amount to the remaining battery charge. The control unit can perform these arithmetic processes in chronological order in accordance with the first operation schedule. Thus, the battery consumption amount on the assumption that the first BEV is operated according to the first operation schedule can be accurately estimated.

Further, the information processing device according to this disclosure may estimate the remaining battery charge taking into account that the battery of the first BEV is charged in a place other than the storage place. In this case, in the information processing device according to this disclosure, the control unit may specify a first place that is a place other than the storage place and includes a charging station among places where the first BEV is parked on the assumption that the first BEV is operated according to the first operation schedule. The control unit may specify a second length of time for which the first BEV is parked in the first place on the assumption that the first BEV is operated according the first operation schedule. The control unit may calculate a second charging amount of the battery on the assumption that the second length of time is a length of a charging time of the battery. The control unit may calculate the remaining battery charge based on the battery consumption amount, the first charging amount, and the second charging amount. For example, for a period in the first period during which the first BEV travels, the control unit may subtract the battery consumption amount from the remaining battery charge. For a period in the first period during which the first BEV is parked in the storage place, the control unit may add the first charging amount to the remaining battery charge. Further, for a period in the first period during which the first BEV is parked in the first place, the control unit may add the second charging amount to the remaining battery charge. The control unit can perform these arithmetic processes in chronological order in accordance with the first operation schedule. Thus, the remaining battery charge on the assumption that the first BEV is operated according to the first operation schedule can be more accurately estimated.

The first information according to this disclosure may further include information about a first charging station that is a charging station suitable to charge the battery of the first BEV. In this case, the control unit of the information processing device according to this disclosure may specify a travel route of the first BEV on the assumption that the first BEV is operated according to the first operation schedule. The control unit may specify a point on the specified travel route at which a timing of charging comes. The control unit may determine, as the first charging station, a charging station that is located on the travel route within a predetermined distance from the point at which the timing of charging comes. The predetermined distance here is, for example, a distance that the first BEV can travel with a remaining battery charge equivalent to the aforementioned threshold value. Thus, the user of the internal combustion engine vehicle can predict a charging place of the first BEV in addition to the timing of charging of the first BEV in the case where the user uses the first BEV in the same manner as the internal combustion engine vehicle during the first period. As a result, hesitation in switching from the internal combustion engine vehicle to the first BEV can be more reliably eliminated.

In the information processing device according to this disclosure, the control unit may determine, as the first charging station, a charging station that is located on the travel route within the predetermined distance from the point at which the timing of charging comes, and that is installed in a place where the first BEV is parked on the assumption that the first BEV is operated according to the first operation schedule. Thus, the user of the internal combustion engine vehicle can predict that, when using the first BEV in the same manner as the internal combustion engine vehicle during the first period, the battery of the first BEV should be charged in the same place as the place where the internal combustion engine vehicle was parked.

In the information processing device according to this disclosure, the control unit may determine, as the first charging station, a charging station that is located on the travel route within the predetermined distance from the point at which the timing of charging comes and that is free. Thus, the user of the internal combustion engine vehicle can predict that, when using the first BEV in the same manner as the internal combustion engine vehicle during the first period, the battery of the first BEV should be charged in a free charging station.

In the information processing device according to this disclosure, the control unit may determine, as the first charging station, a charging station that is located on the travel route within the predetermined distance from the point at which the timing of charging comes and that is least crowded around a time of day when the timing of charging comes. Thus, the user of the internal combustion engine vehicle can ascertain a charging station that is least crowded around the time of day when the battery of the first BEV needs charging in the case where the user uses the first BEV in the same manner as the internal combustion engine vehicle during the first period.

In the information processing device according to this disclosure, the control unit may determine, as the first charging station, a charging station that is located on the travel route within the predetermined distance from the point at which the timing of charging comes and that is equipped with a quick charger. Thus, the user of the internal combustion engine vehicle can predict that, when using the first BEV in the same manner as the internal combustion engine vehicle during the first period, the battery of the first BEV can be charged in a charging station equipped with a quick charger.

The first information according to this disclosure may include information about a third length of time that is a length of a recommended charging time at the first charging station, in addition to the information about the timing of charging the battery on the assumption that the first BEV is operated according to the first operation schedule and the information about the first charging station. In this case, the control unit of the information processing device according to this disclosure may calculate the remaining battery charge at a point in time when the first BEV arrives at the first charging station. The control unit may calculate the third length of time based on the calculated remaining battery charge. Thus, the user of the internal combustion engine vehicle can predict the length of the charging time at the first charging station in the case where the user switches to the first BEV.

The information processing device according to this disclosure may be a server device that can communicate with an on-board terminal of the internal combustion engine vehicle or a user terminal of the user. Further, the information processing device according to this disclosure may be an on-board terminal or a user terminal.

### Embodiment

In the following, a specific embodiment of this disclosure will be described based on the drawings. In this embodiment, an example will be described in which the information processing device according to this disclosure is applied to a system for providing a BEV charging simulation service (hereinafter also referred to as a “charging simulation system”) to a user of an internal combustion engine vehicle. Unless otherwise noted, configurations described in this embodiment are not intended to limit the technical scope of this disclosure thereto.

System Overview

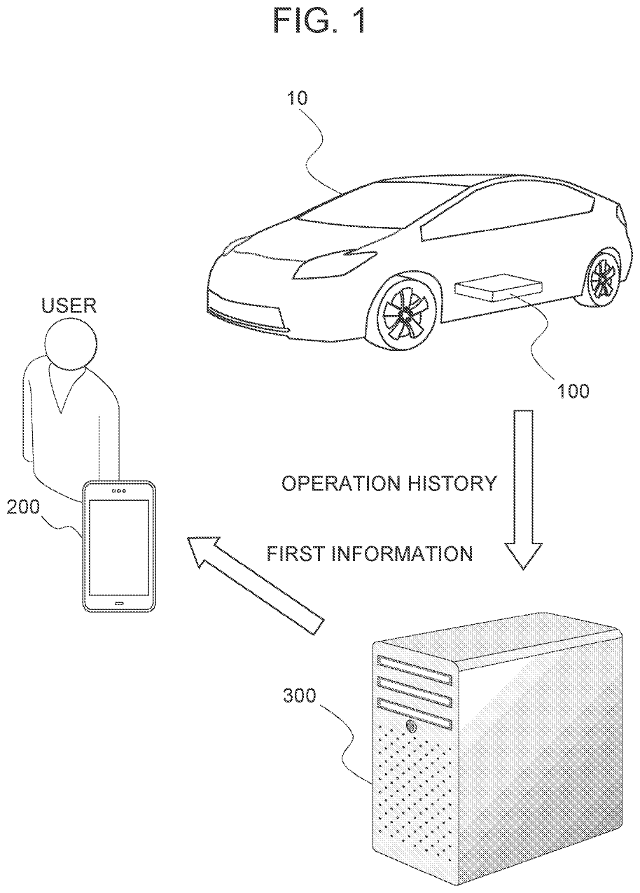

FIG. 1 is a view showing an overview of the charging simulation system in the embodiment. The charging simulation system in the embodiment includes, in its configuration, an on-board terminal 100 installed in an internal combustion engine vehicle 10, a user terminal 200 used by a user of the internal combustion engine vehicle 10, and a server device 300. Each of the on-board terminal 100 and the user terminal 200 is connected to the server device 300 through a network N1.

The internal combustion engine vehicle 10 is a vehicle that travels using an internal combustion engine as a prime mover. The on-board terminal 100 collects an operation history of the internal combustion engine vehicle 10 for a first period and transmits the collected operation history to the server device 300. The operation history is data in which actual driving states and positions of the internal combustion engine vehicle 10 during the first period are recorded in chronological order. The data thus recorded shows an actual operation schedule of the internal combustion engine vehicle during the first period (e.g., a parking start time, parking end time, parking position, travel start time, travel start position, travel end time, travel end position, travel route, and traveling positions at respective times of day). The first period may be, for example, one day or one week. The first period may also be a period that is arbitrarily specified by the user.

The server device 300 generates first information based on the operation history received from the on-board terminal 100. The first information is information about a timing of charging the battery of the first BEV on the assumption that the first BEV is operated according to the operation schedule shown by the operation history. Specifically, the first information includes information showing whether the battery needs charging during travel of the first BEV on the assumption that the first BEV is operated according to the operation schedule of the internal combustion engine vehicle 10 during the first period, information showing a timing of charging when the battery needs charging, and information showing a charging place (charging station) when the battery needs charging.

The server device 300 in this embodiment performs a simulation of a case where the first BEV is operated according to the same operation schedule as the operation schedule of the internal combustion engine vehicle 10 during the first period, and determines whether the battery needs charging during travel of the first BEV. When it is determined that the battery of the first BEV needs charging, the server device 300 determines a timing of charging and a charging place. The server device 300 generates the first information based on the result of this determination and provides the generated first information to the user terminal 200. The first BEV used for this simulation may be a BEV of which the size class is the same or similar to that of the internal combustion engine vehicle 10, a BEV of which the price is similar to that of the internal combustion engine vehicle 10, a BEV manufactured by the same manufacturer as the internal combustion engine vehicle 10, or a BEV specified by the user of the internal combustion engine vehicle 10 (e.g., a BEV to which the user is considering switching from the internal combustion engine vehicle 10).

The user terminal 200 outputs the first information provided from the server device 300 and presents it to the user. The user presented with the first information can predict, before switching to the first BEV, the timing of charging and the charging place in the case where the user uses the first BEV in the same manner as the internal combustion engine vehicle 10 during the first period. Thus, the user can predict when and where to charge the battery when using the first BEV in the same manner as the internal combustion engine vehicle 10 during the first period. This can eliminate the hesitation of the user in switching from the internal combustion engine vehicle 10 to the first BEV.

System Configuration

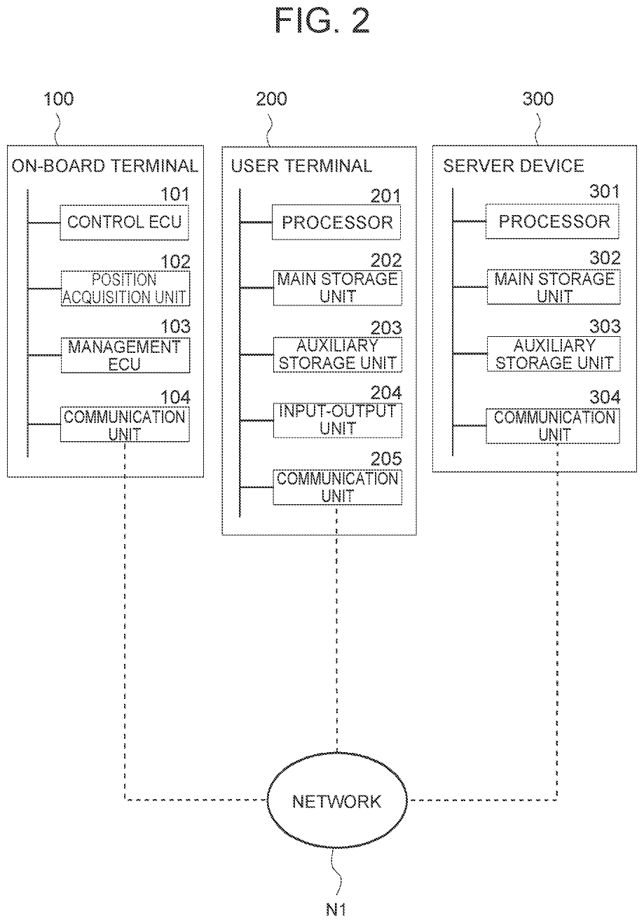

FIG. 2 is a diagram showing one example of the hardware configuration of each of the on-board terminal 100, the user terminal 200, and the server device 300 that are included in the charging simulation system in this embodiment.

The on-board terminal 100 is a computer installed in the internal combustion engine vehicle 10. As shown in FIG. 2, the on-board terminal 100 includes a control electronic control unit (ECU) 101, a position acquisition unit 102, a management ECU 103, a communication unit 104, etc. The control ECU 101, the position acquisition unit 102, the management ECU 103, and the communication unit 104 are connected to one another through an in-vehicle network (CAN-BUS) or the like that complies with the Controller Area Network (CAN) standard. The hardware configuration of the on-board terminal 100 is not limited to the example shown in FIG. 2 and, as necessary, the constituent elements may be omitted or substituted or other constituent elements may be added.

The control ECU 101 is an ECU that controls various devices installed in the internal combustion engine vehicle 10, and includes, in its configuration, a plurality of ECUs for respective systems of devices. For example, the control ECU 101 includes an ECU that controls the internal combustion engine that is the prime mover of the internal combustion engine vehicle 10, an ECU that controls a braking device of the internal combustion engine vehicle 10, an ECU that controls a transmission of the internal combustion engine vehicle 10, an ECU that controls a suspension of the internal combustion engine vehicle 10, an ECU that controls an air conditioner of the internal combustion engine vehicle 10, and an ECU that controls a multimedia device installed in the internal combustion engine vehicle 10. The control ECU 101 controls the prime mover, the braking device, the transmission, the suspension, the air conditioner, the multimedia device, etc. based on detection signals of various sensors installed in the internal combustion engine vehicle 10.

The position acquisition unit 102 is a device that acquires position information showing a current position of the internal combustion engine vehicle 10. For example, the position acquisition unit 102 includes a GPS receiver etc. in its configuration. The position information acquired by the position acquisition unit 102 is, for example, the latitude and the longitude. However, the position acquisition unit 102 is not limited to a GPS receiver, and the position information acquired by the position acquisition unit 102 is not limited to the latitude and the longitude. The position information acquired by the position acquisition unit 102 is output to the management ECU 103. As the position acquisition unit 102, a position acquisition unit included in a car navigation system installed in the internal combustion engine vehicle 10 can also be used.

The management ECU 102 acquires a driving state and position information of the internal combustion engine vehicle 10 through the control ECU 101 and the position acquisition unit 102 in a predetermined cycle, and records the driving state and the position information in chronological order so as to be associated with each other. Each time the first period elapses, the management ECU 103 transmits record data for the first period to the server device 300 through the communication unit 104. The record data for the first period that is thus transmitted from the management ECU 103 to the server device 300 corresponds to the “operation history” according to this disclosure. The record data that has been transmitted to the server device 300 may be deleted from the management ECU 103. The driving state of the internal combustion engine vehicle 10 is, for example, on or off of an ignition switch (whether an internal combustion engine is operating or not operating). However, the driving state of the internal combustion engine vehicle 10 is not limited to on or off of the ignition switch, and may also include a travel speed, an accelerator operation amount, on or off of a brake switch, on or off of the air conditioner, on or off of the multimedia device, etc. The position information of the internal combustion engine vehicle 10 includes information showing the position of the internal combustion engine vehicle 10 while it is operated (when the ignition switch is on) and the position of the internal combustion engine vehicle 10 while it is not operated (when the ignition switch is off).

The communication unit 104 is an interface for connecting the on-board terminal 100 to the network N1 outside the vehicle. For example, the communication unit 104 connects to the network N1 using a wireless communication network, and communicates with the server device 300 through the network N1. In this embodiment, the communication unit 104 transmits the operation history received from the management ECU 103 through the in-vehicle network to the server device 300 through the network N1. The wireless communication network is, for example, a mobile communication network, such as 5th-Generation (5G) or Long Term Evolution (LTE), or Wi-Fi. The network N1 is, for example, a wide area network (WAN) that is a global public communication network, such as the Internet, or other communication network.

The user terminal 200 functions to present the first information to the user through the server device 300. Specifically, the user terminal 200 presents the user with information showing whether the battery needs charging during travel of the first BEV on the assumption that the first BEV is operated according to the same operation schedule as the operation schedule of the internal combustion engine vehicle 10 during the first period, information showing a timing of charging when the battery of the first BEV needs charging, and information showing a charging place when the battery of the first BEV needs charging. This function is realized, for example, by an application program installed in the user terminal 200 or by a Web browser that runs on the user terminal 200.

The user terminal 200 that realizes the above-described function is, for example, a computer used by an individual, such as a personal computer, a smartphone, a mobile phone, a tablet computer, or a personal information terminal. As shown in FIG. 2, the user terminal 200 includes, in its configuration, a processor 201, a main storage unit 202, an auxiliary storage unit 203, an input-output unit 204, a communication unit 205, etc. The processor 201, the main storage unit 202, the auxiliary storage unit 203, the input-output unit 204, and the communication unit 205 are connected to one another by a bus. The configuration of the user terminal 200 is not limited to the example shown in FIG. 2 and, as necessary, the constituent elements may be changed or omitted or other constituent elements may be added.

The processor 201 is, for example, a central processing unit (CPU) or a digital signal processor (DSP). The processor 201 controls the user terminal 200 by performing various arithmetic operations for information processing.

The main storage unit 202 is a computer-readable recording medium. The main storage unit 202 is a storage device that is used as a recording area for loading a program stored in the auxiliary storage unit 203 or as a buffer for temporarily storing a result of an arithmetic operation of the processor 201 etc. The main storage unit 202 includes, for example, a random-access memory (RAM) and a read-only memory (ROM) in its configuration.

The auxiliary storage unit 203 is a computer-readable recording medium. The auxiliary storage unit 203 stores various programs, and various pieces of data, various tables, etc. that are used by the processor 201 to execute various programs. The auxiliary storage unit 203 includes, for example, an erasable programmable ROM (EPROM) and a hard disk drive (HDD). The auxiliary storage unit 203 can include a removable medium, i.e., a portable recording medium. For example, the removable medium may be a disc recording medium, such as a compact disc (CD) or a digital versatile disc (DVD), or may be a universal serial bus (USB) memory. The programs stored in the auxiliary storage unit 203 include, in addition to an operating system (OS), an application program for realizing the function of presenting the first information to the user through the server device 300. Some or all of the pieces of information stored in the auxiliary storage unit 203 may be stored in the main storage unit 202.

The communication unit 205 is an interface for connecting the user terminal 200 to the network N1. In this embodiment, the communication unit 205 connects to the network N1 and communicates with the server device 300 through the network N1. The communication unit 205 is, for example, a local area network (LAN) interface board or a wireless communication circuit for wireless communication.

While receiving input operation performed by the user, the input-output unit 204 presents information to the user. For example, the input-output unit 204 includes, in its configuration, a touch panel display and a control circuit thereof. In this embodiment, the input-output unit 204 displays the first information provided from the server device 300 on the touch panel display.

The server device 300 is a computer that is operated by a provider of the charging simulation service, and corresponds to the “information processing device” according to this disclosure. The server device 300 simulates travel of the first BEV based on the operation history acquired from the on-board terminal 100 and generates the first information. The server device 300 provides the generated first information to the user terminal 200. Such a server device 300 may be configured to be able to realize a Web server for interacting with the user terminal 200. In this case, the user terminal 200 can present the first information to the user through the server device 300 by accessing the Web server through the browser. The server device 300 may provide the first information to the user terminal 200 by means other than the Web server. For example, the first information may be provided from the server device 300 to the user terminal 200 by an application program installed in the user terminal 200 and a predetermined protocol.

As shown in FIG. 2, the server device 300 that realizes the above-described function includes, in its configuration, a processor 301, a main storage unit 302, an auxiliary storage unit 303, a communication unit 304, etc. The processor 301, the main storage unit 302, the auxiliary storage unit 303, and the communication unit 304 are connected to one another by a bus. The hardware configuration of the server device 300 is not limited to the example shown in FIG. 2 and, as necessary, the constituent elements may be omitted or substituted or other constituent elements may be added.

The server device 300 realizes the above-described function as the processor 301 loads a program stored in a recording medium onto a work area of the main storage unit 302 and executes the program. A series of processes executed in the server device 300 can be executed by hardware but can also be executed by software.

As the processor 301, the main storage unit 302, and the auxiliary storage unit 303 are the same as the processor 201, the main storage unit 202, and the auxiliary storage unit 203, respectively, of the user terminal 200, the description thereof will be omitted. However, the programs stored in the auxiliary storage unit 303 include a program for realizing the function of providing the charging simulation service to the user. Some or all of the pieces of information stored in the auxiliary storage unit 303 may be stored in the main storage unit 302.

The communication unit 304 performs transmission and reception of information between an external device (e.g., the on-board terminal 100 and the user terminal 200) and the server device 300. The communication unit 304 is, for example, an LAN interface board or a wireless communication circuit for wireless communication. The LAN interface board or the wireless communication circuit is connected to the network N1.

Functional Configuration of Server Device

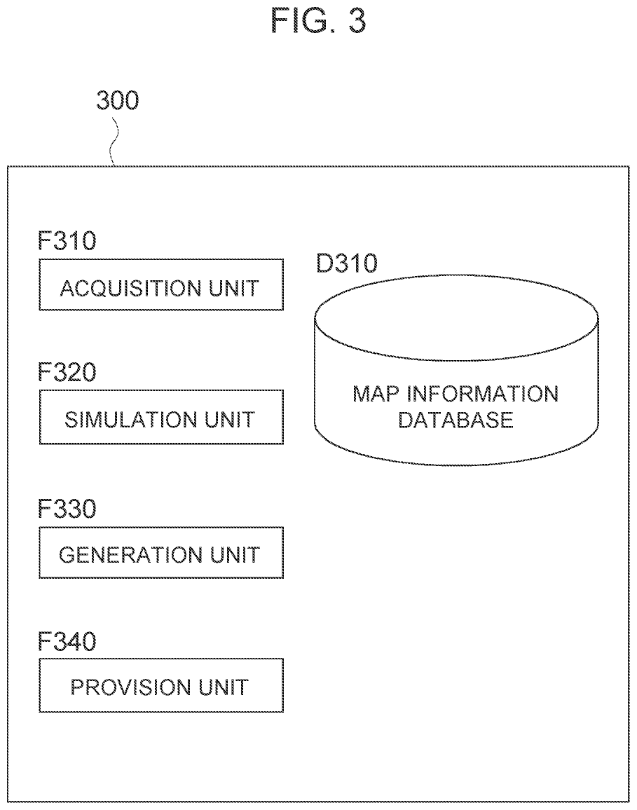

Here, the functional configuration of the server device 300 in this embodiment will be described based on FIG. 3. FIG. 3 is a block diagram showing one example of the functional configuration of the server device 300 in this embodiment. As shown in FIG. 3, the server device 300 in this embodiment has, as its functional components, an acquisition unit F310, a simulation unit F320, a generation unit F330, a provision unit F340, and a map information database D310.

The acquisition unit F310, the simulation unit F320, the generation unit F330, and the provision unit F340 are realized as the processor 301 of the server device 300 loads programs in the auxiliary storage unit 303 onto the main storage unit 302 and executes the programs. The acquisition unit F310, the simulation unit F320, the generation unit F330, and the provision unit F340 may be realized by a hardware circuit, such as an application-specific integrated circuit (ASIC) or a field programmable gate array (FPGA).

In this embodiment, the processor 301 that realizes the functional components, the acquisition unit F310, the simulation unit F320, the generation unit F330, and the provision unit F340, corresponds to the “control unit” according to this disclosure.

The map information database D310 is established as a database management system (DBMS) manages the data stored in the auxiliary storage unit 303. The database management system is a program executed by the processor 301 of the server device 300.

One of the functional components of the server device 300 or some of the processes of these functional components may be executed by another computer connected to the network N1. The functional configuration of the server device 300 is not limited to the example shown in FIG. 3 and, as necessary, the constituent elements may be omitted or changed or other constituent elements may be added.

In the map information database D310, map data of roads and charging stations is registered. As the map data registered in the map information database D310, data in a commonly known form can be used. For example, the map data registered in the map information database D310 may include a plurality of map meshes corresponding to a plurality of areas divided by the latitude and the longitude. Each map mesh may include a road link showing a road passable for an automobile, information for locating the position of each road link on the map (e.g., the latitude and the longitude or the address), and information for locating the position of each charging station on the map (e.g., the latitude and the longitude or the address).

The acquisition unit F310 acquires the operation history from the on-board terminal 100. Specifically, when the operation history is transmitted from the on-board terminal 100 to the server device 300, the acquisition unit F310 acquires the operation history through the communication unit 304. The operation history is data in which actual driving states and position information of the internal combustion engine vehicle 10 during the first period are recorded in chronological order so as to be associated with each other, and shows the operation schedule of the internal combustion engine vehicle 10 during the first period. The operation history acquired by the acquisition unit F310 is transferred to the simulation unit F320.

The simulation unit F320 simulates changes over time in the remaining battery charge on the assumption that the first BEV is operated according to the operation schedule shown by the operation history received from the acquisition unit F310. Specifically, the simulation unit F320 first generates an operation schedule (hereinafter also referred to as a “virtual schedule”) of the first BEV on the assumption that the first BEV is operated according to the operation schedule shown by the operation history.

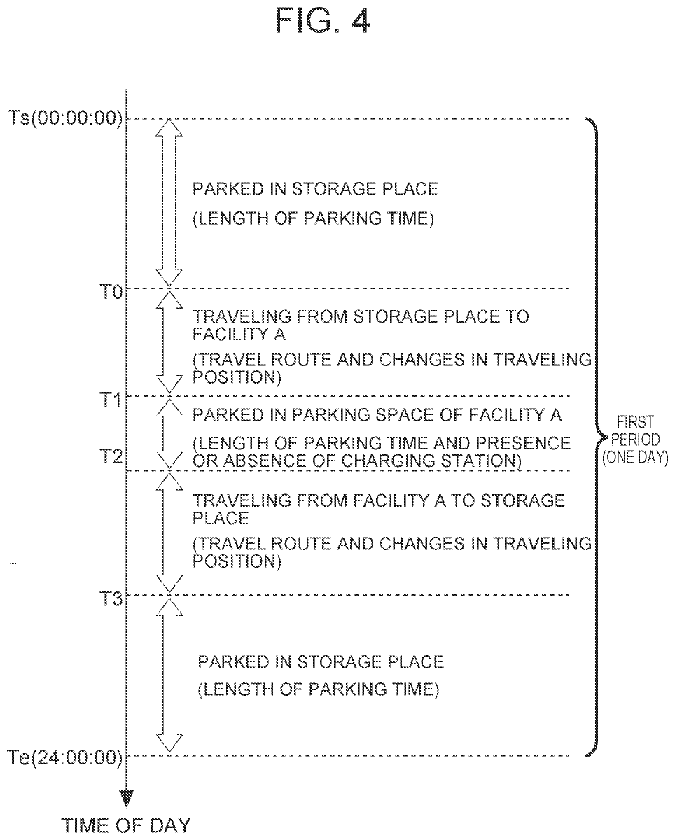

Here, one example of the virtual schedule will be described based on FIG. 4. FIG. 4 is a chart schematically showing one example of the virtual schedule. Reference sign Ts in FIG. 4 denotes a start time of the first period. Reference sign Te in FIG. 4 denotes an end time of the first period. The example shown in FIG. 4 is a virtual schedule in the case where the first period is one day. Therefore, Ts is 0 o'clock of the current day and Te is 24 o'clock of the current day. When the first period is one week, a virtual schedule from 0 o'clock on Sunday of the corresponding week to 24 o'clock on Saturday of the same week should be generated.

In the example shown in FIG. 4, it is assumed that the first BEV is parked in a storage place during a period from time Ts to time T0 in the first period. The storage place is a parking space at the home of the user, a parking space that the user is renting on a monthly contract, or the like. The schedule from time Ts to time T0 is set based on the driving states and the position information of the internal combustion engine vehicle 10 during the period from time Ts to time T0 in the operation history acquired by the acquisition unit F310. Thus, when the ignition switch of the internal combustion engine vehicle 10 is off and the position information of the internal combustion engine vehicle 10 matches the position of the storage place during the period from time Ts to time T0 in the operation history acquired by the acquisition unit F310, the simulation unit F320 determines that the internal combustion engine vehicle 10 has been parked in the storage place during the period from time Ts to time T0. Accordingly, the simulation unit F320 assumes that the first BEV is parked in the storage place during the period from time Ts to time T0. In this case, the simulation unit F320 specifies the length of the parking time from time Ts to time T0.

When the ignition switch of the internal combustion engine vehicle 10 is on and the position information of the internal combustion engine vehicle 10 changes with time from the storage place to a facility A during the period from time T0 to time T1 in the operation history acquired by the acquisition unit F310, the simulation unit F320 determines that the internal combustion engine vehicle 10 has traveled from the storage place to the facility A during the period from time T0 to time T1. Accordingly, the simulation unit F320 assumes that the first BEV travels from the storage place to the facility A during the period from time T0 to time T1. In this case, the simulation unit F320 specifies the travel route from the storage place to the facility A and changes in the traveling position of the first BEV along the travel route by collating the changes in the position information of the internal combustion engine vehicle 10 during the period from time T0 to time T1 and the map data in the map information database D310.

When the ignition switch of the internal combustion engine vehicle 10 is off and the position information of the internal combustion engine vehicle 10 matches the position of the facility A during the period from time T1 to time T2 in the operation history acquired by the acquisition unit F310, the simulation unit F320 determines that the internal combustion engine vehicle 10 has been parked in the facility A during the period from time T1 to time T2. Accordingly, the simulation unit F320 assumes that the first BEV is parked in the facility A during the period from time T1 to time T2. In this case, the simulation unit F320 specifies the length of the parking time from time T1 to time T2. Further, the simulation unit F320 ascertains whether there is a charging station in the facility A based on the map data in the map information database D310.

When the ignition switch of the internal combustion engine vehicle 10 is on and the position information of the internal combustion engine vehicle 10 changes with time from the facility A to the storage place during the period from time T2 to time T3 in the operation history acquired by the acquisition unit F310, the simulation unit F320 determines that the internal combustion engine vehicle 10 has traveled from the facility A to the storage place during the period from time T2 to time T3. Accordingly, the simulation unit F320 assumes that the first BEV travels from the facility A to the storage place during the period from time T2 to time T3. In this case, the simulation unit F320 specifies the travel route from the facility A to the storage place and changes in the traveling position of the first BEV along the travel route by collating the changes in the position information of the internal combustion engine vehicle 10 during the period from time T2 to time T3 and the map data in the map information database D310.

When the ignition switch of the internal combustion engine vehicle 10 is off and the position information of the internal combustion engine vehicle 10 matches the position of the storage place during the period from time T3 to time Te in the operation history acquired by the acquisition unit F310, the simulation unit F320 determines that the internal combustion engine vehicle 10 has been parked in the storage place during the period from time T3 to time Te. Accordingly, the simulation unit F320 assumes that the first BEV is parked in the storage place during the period from time T3 to time Te. In this case, the simulation unit F320 specifies the length of the parking time from time T3 to time Te.

When the virtual schedule as shown in FIG. 4 is generated, the simulation unit F320 simulates changes over time in the remaining battery charge on the assumption that the first BEV is operated according to this virtual schedule. This simulation is performed on the assumption that charging equipment is installed in the storage place.

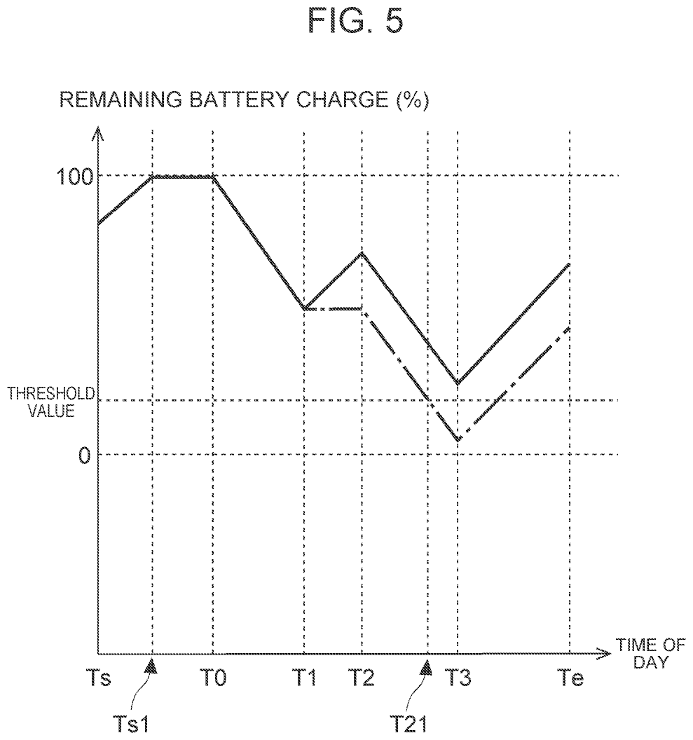

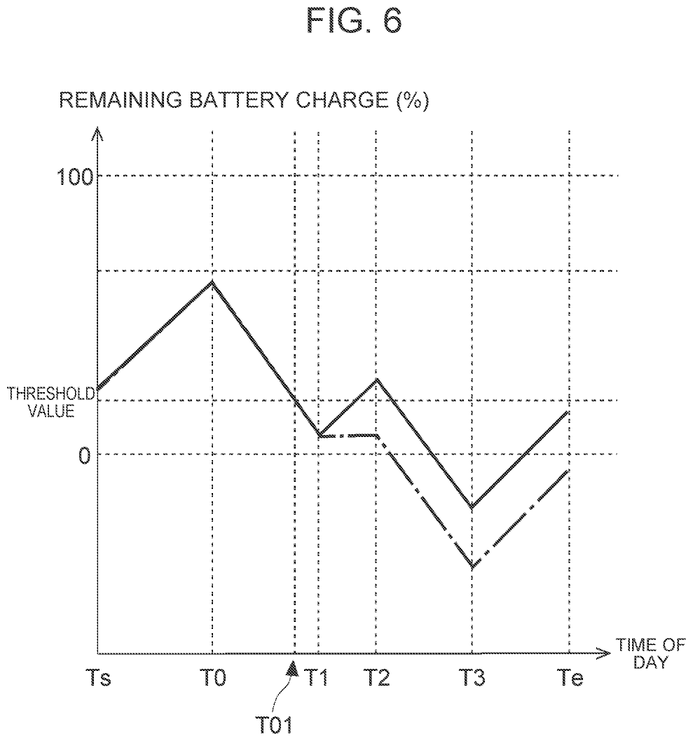

Here, a method of simulating the remaining battery charge of the first BEV will be described based on FIG. 5 and FIG. 6. FIG. 5 and FIG. 6 are graphs showing changes over time in the remaining battery charge on the assumption that the first BEV is operated according to the virtual schedule of FIG. 4 described above. The difference between the example shown in FIG. 5 and the example shown in FIG. 6 is the remaining battery charge at the start time of the first period (time Ts in FIG. 5 and FIG. 6). Specifically, the remaining battery charge at start time Ts of the first period is larger in the example shown in FIG. 5 than in the example shown in FIG. 6. The remaining battery charge at start time Ts of the first period may be a remaining battery charge at an end point (e.g., 24 o'clock of the previous day) of the preceding first period (e.g., the previous day).

The solid lines in FIG. 5 and FIG. 6 show changes over time in the remaining battery charge in the case where a charging station is installed in the facility A, and the long dashed short dashed lines in FIG. 5 and FIG. 6 show changes over time in the remaining battery charge in the case where a charging station is not installed in the facility A. “Threshold value” in FIG. 5 and FIG. 6 is a remaining battery charge by which it is determined that the battery needs charging when the remaining battery charge has decreased to this threshold value, and is, for example, a remaining battery charge of about 10% to 20%. While in reality the remaining battery charge cannot fall below 0%, here changes in the remaining battery charge below 0% are also shown.

In the examples shown in FIG. 5 and FIG. 6, the simulation unit F320 first simulates changes over time in the remaining battery charge during the period from time Ts to time T0. Since the first BEV is charged in the storage place during this period, the remaining battery charge increases as time passes. Therefore, the simulation unit F320 obtains the changes over time in the remaining battery charge during this period by integrating the remaining battery charges per unit time as time passes. In the example shown in FIG. 5, the remaining battery charge reaches 100% during this period (at time Ts1 in FIG. 5), so that the remaining battery charge remains 100% during the period from time Ts1 to time T0. The length of the parking time from time Ts to time T0 in FIG. 5 and FIG. 6 corresponds to the “first length of time” according to this disclosure. The remaining battery charge from time Ts to time T0 in FIG. 5 and FIG. 6 corresponds to the “first charging amount” according to this disclosure.

When the changes over time in the remaining battery charge during the period from time Ts to time T0 are obtained, the simulation unit F320 simulates changes over time in the remaining battery charge during the period from time T0 to time T1. During this period, the first BEV travels from the storage place toward the facility A, and therefore the remaining battery charge decreases with time. This is because, during the period from time T0 to time T1, the distance traveled by the first BEV increases as time passes and the remaining battery charge decreases accordingly. Therefore, the simulation unit F320 obtains the changes over time in the remaining battery charge during this period by repeatedly performing a process of subtracting a battery consumption amount per unit distance (e.g., 1 km) from the remaining battery charge as the travel distance increases.

The battery consumption amount per unit distance may be set according to factors such as the gradient of the travel route, the travel speed (the same travel speed as when the internal combustion engine vehicle 10 has traveled this travel route), the rates of acceleration and deceleration (the same rates of acceleration and deceleration as when the internal combustion engine vehicle 10 has traveled this travel route), on or off of the air conditioner (the same on or off of the air conditioner as when the internal combustion engine vehicle 10 has traveled this travel route), and on or off of the multimedia device (the same on or off of the multimedia device as when the internal combustion engine vehicle 10 has traveled this travel route). As another method, the battery consumption amount per unit distance may be a battery consumption amount per unit distance on the assumption that the first BEV travels under conditions under which the power consumption rate is highest. In this embodiment, to reduce the arithmetic processing load on the server device 300, the battery consumption amount per unit distance on the assumption that the first BEV travels under conditions under which the power consumption rate is highest is used.

When the changes over time in the remaining battery charge during the period from time T0 to time T1 is obtained, the simulation unit F320 simulates changes over time in the remaining battery charge during the period from time T1 to time T2. During this period, the first BEV is parked at the facility A. When a charging station is installed in the facility A, this period can be allocated for charging the battery of the first BEV. Therefore, when a charging station is installed in the facility A, the simulation unit F320 obtains the changes over time in the remaining battery charge during this period by integrating the remaining battery charges per unit as time passes. As a result, as indicated by the solid lines in FIG. 5 and FIG. 6, the remaining battery charge increases as time passes. In this case, the facility A corresponds to the “first place” according to this disclosure. The length of the parking time from time T1 to time T2 corresponds to the “second length of time” according to this disclosure. The battery charging amount from time T1 to time T2 corresponds to the “second charging amount” according to this disclosure. The battery charging amount per unit time may be set according to the type, the rating, etc. of a charger installed in the facility A. Information about the type, the rating, etc. of the charger installed in the facility A may be stored in the map information database D310 along with information for locating the position of each charging station on the map, or may be stored in a database separate from the map information database D310.

When a charging station is not installed in the facility A, the battery of the first BEV cannot be charged using this period, and therefore the simulation unit F320 does not increase or decrease the remaining battery charge during the period from time T1 to time T2. As a result, as indicated by the long dashed short dashed lines in FIG. 5 and FIG. 6, the remaining battery charge during this period remains substantially constant (the same as the remaining battery charge at time T1).

When the changes over time in the remaining battery charge during the period from time T1 to time T2 are obtained, the simulation unit F320 simulates changes over time in the remaining battery charge during the period from time T2 to time T3. During this period, the first BEV travels from the facility A toward the storage place, and therefore the remaining battery charge decreases with time. Therefore, the simulation unit F320 obtains the changes over time in the remaining battery charge during this period by repeatedly performing a process of subtracting the battery consumption amount per unit distance from the battery capacity as the travel distance increases. Also in this case, the battery consumption amount per unit distance on the assumption that the first BEV travels under condition under which the power consumption rate is highest is used.

When the changes over time in the remaining battery charge during the period from time T2 to time T3 are obtained, the simulation unit F320 simulates changes over time in the remaining battery charge during the period from time T3 to time Te. During this period, the battery of the first BEV is charged in the storage place, so that the remaining battery charge increases as time passes. Therefore, the simulation unit F320 obtains the changes over time in the remaining battery charge during this period by integrating the battery charging amounts per unit time as time passes. The length of time (the length of the parking time) from time T3 to time Te in FIG. 5 and FIG. 6 also corresponds to the “first length of time” according to this disclosure. The battery charging amount from time T3 to time Te in FIG. 5 and FIG. 6 also corresponds to the “first charging amount ” according to this disclosure.

After the simulation of the remaining battery charge is performed by the method as described above, the simulation unit F320 determines whether the battery needs charging during travel of the first BEV based on the simulation result. Here, if the simulation result as indicated by the solid line in FIG. 5 is obtained, it is estimated that the remaining battery charge does not decrease to the threshold value throughout all the stages of the virtual schedule. Therefore, the simulation unit F320 determines that the battery does not need charging during travel of the first BEV when the first BEV travels according to the virtual schedule.

When the simulation result as indicated by the long dashed short dashed line in FIG. 5 is obtained, it is estimated that the remaining battery charge decreases to the threshold value during travel from the facility A to the storage place (at time T21 in FIG. 5). Therefore, the simulation unit F320 determines that battery needs charging during travel of the first BEV when the first BEV travels according to the virtual schedule. When this determination result is obtained, the simulation unit F320 determines time T21 during travel from the facility A to the storage place as the timing of charging. Further, the simulation unit F320 determines a first charging station. The first charging station is a charging station suitable to charge the battery of the first BEV at the timing of charging or at a timing before or after the timing of charging.

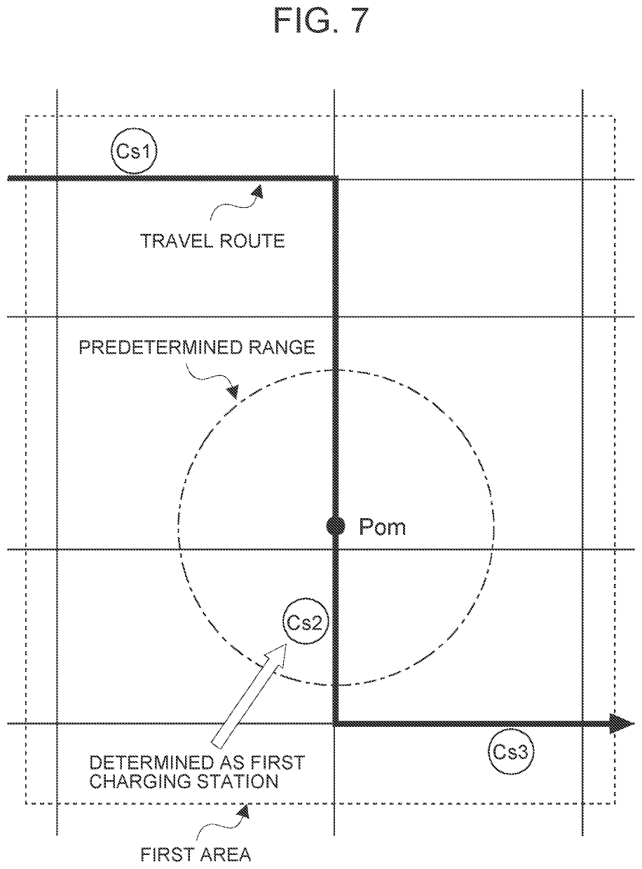

Here, one example of the method of determining the first charging station will be described based on FIG. 7. FIG. 7 is a view showing a road map of a first area. The first area is a region, such as a city, a ward, a town, or a village, including a first point (Pom in FIG. 7). The first point Pom is a traveling position on the travel route of the first BEV at the time of day when the timing of charging comes. In the simulation result indicated by the long dashed short dashed line in FIG. 5, the traveling position of the first BEV at time T21 in FIG. 5 corresponds to the first point Pom. Reference signs Cs1, Cs2, and Cs3 in FIG. 7 denote charging stations inside the first area.

To specify the first charging station, the simulation unit F320 first specifies the first point Pom. Specifically, the simulation unit F320 specifies the traveling position of the first BEV at time T21 based on the virtual schedule. As another method, the simulation unit F320 may extract the position information of the internal combustion engine vehicle 10 at time T21 from the operation history of the internal combustion engine vehicle 10 and set the position shown by the extracted position information as the first point Pom.

The simulation unit F320 accesses the map information database D310 and specifies the first area including the first point Pom. The simulation unit F320 extracts, from the map information database D310, charging stations that are located on the travel route of the first BEV (Cs1, Cs2, and Cs3 in FIG. 7) among charging stations located in the first area. The simulation unit F320 selects a charging station that is located within a predetermined distance from the first point Pom from among the extracted charging stations. The simulation unit F320 determines the selected charging station as the first charging station.

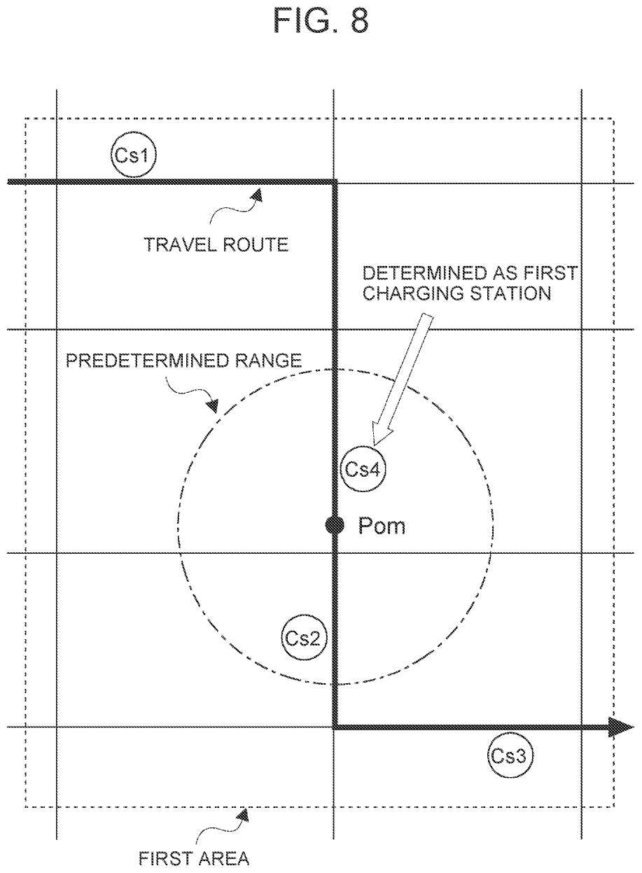

As shown in FIG. 8, a case where there is more than one charging station located within the predetermined distance from the first point Pom (e.g., Cs2 and Cs4 in FIG. 8) is also conceivable. In this case, the simulation unit F320 may determine, as the first charging station, a charging station among these charging stations that is located at a position closest from the first point Pom (e.g., Cs4 in FIG. 8). In the example shown in FIG. 8, the charging station Cs4 determined as the first charging station is located on a route that the first BEV travels before the first point Pom. In such a case, the simulation unit F320 may correct the timing of charging to a time of day when the first BEV travels the position of the charging station Cs4. When there is no charging station on the travel route within the predetermined distance from the first point Pom, the simulation unit F320 may determine, as the first charging station, a charging station that is not located on the travel route and that is located within the predetermined distance from the first point Pom. As another method, when there is no charging station on the travel route within the predetermined distance from the first point Pom, the simulation unit F320 may determine, as the first charging station, a charging station that is located on a route that the first BEV travels before the travel route within the predetermined distance from the first point Pom and that is closest from the first point Pom.

When the simulation results as indicated by the solid line and the long dashed short dashed line in FIG. 6 are obtained, it is estimated that the remaining battery charge decreases to the threshold value during travel from the storage place to the facility A (at time T01 in FIG. 6). Therefore, the simulation unit F320 determines that the battery needs charging when the first BEV travels according to the virtual schedule. When this determination result is obtained, the simulation unit F320 determines time T01 during travel from the storage place to the facility A as the timing of charging. Further, the simulation unit F320 determines the first charging station. The method of determining the first charging station is the same as the method described in the description of FIG. 7 and FIG. 8.

The simulation result of the case where the first BEV travels according to the virtual schedule and the determination result about whether the battery needs charging are transferred from the simulation unit F320 to the generation unit F330. When it is determined that the battery needs charging, in addition to the simulation result and the determination result, information about the timing of charging and the first charging station (charging place) is also transferred from the simulation unit F320 to the generation unit F330.

Here, the description of FIG. 3 will be resumed. The generation unit F330 generates first information based on the information received from the simulation unit F320. In the case where it is determined by the simulation unit F320 that the battery does not need charging, the generation unit F330 generates first information including information showing the virtual schedule, information showing the simulation result, and information showing that the battery does not need charging. In the case where it is determined by the simulation unit F320 that the battery needs charging, the generation unit F330 generates first information including information showing the virtual schedule, information showing the simulation result, information showing that the battery needs charging, information showing the timing of charging, and information on the position of the first charging station. The information on the position of the first charging station may be information on the position of the first charging station indicated on a map. The first information generated by the generation unit F330 is transferred from the generation unit F330 to the provision unit F340.

The provision unit F340 provides the first information generated by the generation unit F330 to the user terminal 200. Specifically, the provision unit F340 may transmit the first information generated by the generation unit F330 to the user terminal 200 through the communication unit 304. When the server device 300 is configured to be able to realize the Web server described above, the provision unit F340 may cause the first information generated by the generation unit F330 to be displayed on the browser of the user terminal 200.

Processing Flow

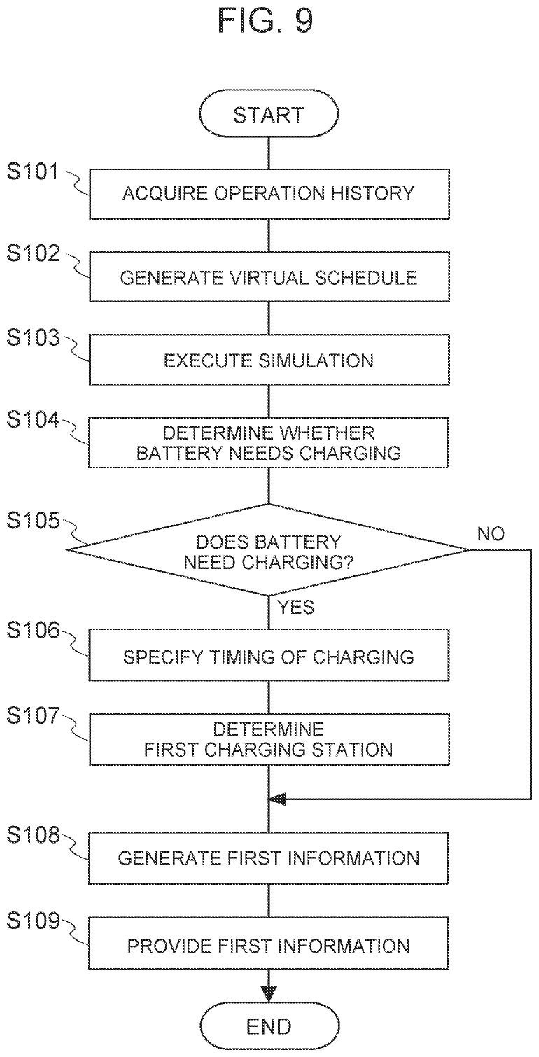

Here, the flow of processing executed in the server device 300 in this embodiment will be described based on FIG. 9. FIG. 9 is a flowchart showing a processing routine that is executed in the server device 300 as the reception of an operation history from the user terminal 200 acts as a trigger. While the subject that executes the processing routine of FIG. 9 is the processor 301 of the server device 300, here the processing flow will be described using functional components of the server device 300 as subjects.

In the processing routine of FIG. 9, the acquisition unit F310 acquires, through the communication unit 304, an operation history transmitted from the on-board terminal 100 to the server device 300 (step S101). As described above, the operation history is data in which the management ECU 103 of the on-board terminal 100 has recorded the driving states and the position information of the internal combustion engine vehicle 10 during the first period in chronological order so as to be associated with each other. The operation history acquired by the acquisition unit F310 is transferred from the acquisition unit F310 to the simulation unit F320. The simulation unit F320 executes the process of step S102 as the reception of the operation history acts as a trigger.

In step S102, the simulation unit F320 generates a virtual schedule of the first BEV based on the operation history of the internal combustion engine vehicle 10 during the first period. The virtual schedule is an operation schedule of the first BEV on the assumption that the first BEV is operated according to the operation schedule shown by the operation history, and is the same as the operation schedule of the internal combustion engine vehicle 10 during the first period. The virtual schedule is generated by the method described above in the description of FIG. 4. After executing the process of step S102, the simulation unit F320 executes the process of step S103.

In step S103, the simulation unit F320 simulates changes over time in the remaining battery charge of the first BEV on the assumption that the first BEV is operated according to the virtual schedule generated in step S102. As described above in the description of FIG. 5 and FIG. 6, this simulation is performed based on the length of the parking time at the storage place, the battery charging amount in the storage place, the battery consumption amount during travel, the parking time in a place to be visited (e.g., the facility A in FIG. 5 and FIG. 6), whether there is battery charging equipment in the place to be visited, etc. Thus, the simulation unit F320 derives a simulation result like the one shown in FIG. 5 or FIG. 6. After executing the process of step S103, the simulation unit F320 executes the process of step S104.

In step S104, the simulation unit F320 determines whether the battery needs charging during travel of the first BEV based on the simulation result of step S103. Specifically, the simulation unit F320 determines whether the remaining battery charge decreases to the threshold value during travel of the first BEV in the simulation result as shown in FIG. 5 or FIG. 6 described above (e.g., during the period from time T0 to time T1 or during the period from time T2 to time T3). When the remaining battery charge decreases to the threshold value during travel of the first BEV, the simulation unit F320 determines in the affirmative in step S105. When the remaining battery charge does not decrease to the threshold value during travel of the first BEV, the simulation unit F320 determines in the negative in step S105.

When it is determined in the affirmative in step S105, the simulation unit F320 executes the process of step S106. In step S106, the simulation unit F320 determines the timing of charging. The timing of charging is a timing when the battery needs charging during travel of the first BEV when the first BEV travels according to the virtual schedule, and is a timing when the remaining battery charge decreases to the threshold value. Here, in the case where the remaining battery charge decreases to the threshold value at time T21 during travel from the facility A to the storage place as in the simulation result indicated by the long dashed short dashed line in FIG. 5, the simulation unit F320 determines time T21 as the timing of charging. In the case where the remaining battery charge decreases to the threshold value at time T01 during travel from the storage place to the facility A as in the simulation result indicated by the long dashed short dashed line in FIG. 6, the simulation unit F320 determines time T01 as the timing of charging. After executing the process of step S106, the simulation unit F320 executes the process of step S107.

In step S107, the simulation unit F320 determines the first charging station.

The first charging station is a charging station (charging place) suitable to charge the battery of the first BEV at the timing of charging or at a timing before or after the timing of charging. To determine such a first charging station, the simulation unit F320 first determines the traveling position (e.g., Pom in FIG. 7 and FIG. 8) of the first BEV at the time of day when the timing of charging comes (e.g., time T21 in FIG. 5 or time T01 in FIG. 6), and specifies this traveling position as the first point Pom.

When the first point Pom is specified, the simulation unit F320 accesses the map information database D310 and specifies a first area including the first point Pom. When the first area is specified, the simulation unit F320 extracts charging stations located in the first area (Cs1 to Cs3 in FIG. 7 or Cs1 to Cs4 in FIG. 8) from the map information database D310.

When the charging stations located in the first area are extracted, the simulation unit F320 selects a charging station that is located within the predetermined distance from the first point Pom from among the extracted charging stations. The simulation unit F320 determines the selected charging station as the first charging station. When there is more than one charging station within the predetermined distance from the first point Pom as shown in FIG. 8 described above (e.g., Cs2 and Cs4 in FIG. 8), the simulation unit F320 determines a charging station that is located at a position closest from the first point Pom (e.g., Cs4 in FIG. 8) as the first charging station. When the first charging station is located on a route that the first BEV travels before the first point Pom, the simulation unit F320 may correct the timing of charging to a time of day at which the first BEV travels the position of the first charging station.

After executing the process of step S107, the simulation unit F320 transfers the virtual schedule generated in step S102, the result of the simulation executed in step S103, the determination result of step S105, the timing of charging specified in step S106 (or the timing of charging corrected in step S107), and the first charging station determined in step S107 to the generation unit F330. The generation unit F330 executes the process of step S108 as the reception of the information from the simulation unit F320 acts as a trigger.

In step S108, the generation unit F330 generates the first information based on the information received from the simulation unit F320. The first information in this case includes information showing the virtual schedule, information showing the simulation result, information showing that the battery needs charging during travel of the first BEV, information showing the timing of charging, and information on the position of the first charging station. The first information generated by the generation unit F330 is transferred from the generation unit F330 to the provision unit F340. The provision unit F340 executes the process of step S109 as the reception of the first information acts as a trigger.

In step S109, the provision unit F340 provides the first information to the user of the internal combustion engine vehicle 10. Specifically, the provision unit F340 transmits the first information to the user terminal 200 through the communication unit 304. Or the provision unit F340 displays the first information on the browser of the user terminal 200 when the user accesses the Web server through the browser of the user terminal 200.

When it is determined in the negative in step S105, the processes of step S106 and step S108 are skipped and the processes of step S108 and step S109 are executed. In this case, the virtual schedule generated in step S102, the result of the simulation executed in step S103, and the determination result of step S105 are transferred from the simulation unit F320 to the generation unit F330. In step S108, the generation unit F330 generates the first information including information showing the virtual schedule, information showing the simulation result, and information showing that the battery does not need charging during travel of the first BEV. In step S109, the provision unit F340 provides the user with the first information including the information showing the virtual schedule, the information showing the simulation result, and the information showing that the battery does not need charging during travel of the first BEV.

According to this embodiment, the user of the internal combustion engine vehicle 10 can predict as to whether the battery needs charging during travel of the first BEV on the assumption that the first BEV is operated according to the same operation schedule (virtual schedule) as the operation schedule of the internal combustion engine vehicle 10 during the first period. Further, in the case where the battery needs charging during travel of the first BEV, the user of the internal combustion engine vehicle 10 can also predict when the battery needs charging. Moreover, in the case where the battery needs charging during travel of the first BEV, the user of the internal combustion engine vehicle 10 can predict as to where the battery should be charged. Therefore, before switching from the internal combustion engine vehicle 10 to the first BEV, the user of the internal combustion engine vehicle 10 can get a rough estimate about the timing of charging, the charging place, etc. of the first BEV in the case where the user uses the first BEV in the same manner as the internal combustion engine vehicle 10 during the first period. In particular, in the case of an operation schedule in which the operation schedule of the internal combustion engine vehicle 10 during the first period is repeated on a daily basis (e.g., an operation schedule when the internal combustion engine vehicle 10 is used by the user to commute to work or school), the user can get a rough estimate about the timing of charging, the charging place, etc. of the first BEV in the case where the user uses the first BEV on a daily basis. As a result, the user can also foresee changes in his or her life pattern etc. in the case where the user switches from the internal combustion engine vehicle 10 to the first BEV.

Thus, according to this embodiment, it is possible to eliminate the user's hesitation in switching from the internal combustion engine vehicle 10 to the first BEV, as well as to encourage the user to switch from the internal combustion engine vehicle 10 to the first BEV.

### MODIFIED EXAMPLE 1

In the above embodiment, the example has been described in which, when there is more than one charging station within the predetermined distance from the first point Pom, a charging station among these charging stations that is closest from the first point Pom is determined as the first charging station. On the other hand, when there is more than one charging station within the predetermined distance from the first point Pom, a station that is installed in a place to be visited by the first BEV among these charging stations may be determined as the first charging station.

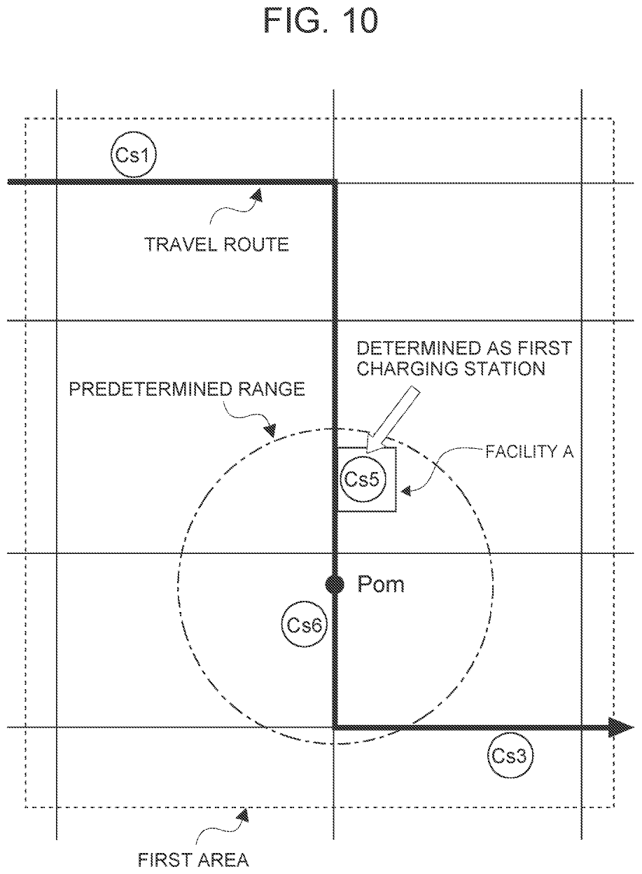

FIG. 10 is a view showing one example of the road map of the first area. In the example shown in FIG. 10, there are two charging stations within the range of the predetermined distance from the first point Pom (Cs5 and Cs6 in FIG. 10). Of these two charging stations Cs5 and Cs6, the charging station Cs5 is a charging station that is installed in the facility A to be visited by the first BEV when the first BEV travels according to the virtual schedule. When there is such a charging station Cs5 within the range of the predetermined distance from the first point Pom, the simulation unit F320 of the server device 300 determines this charging station Cs5 as the first charging station. In the example shown in FIG. 10, as in the example shown in FIG. 8 described above, the charging station Cs5 determined as the first charging station is located on a route that the first BEV travels before the first point Pom. Therefore, the simulation unit F320 may correct the timing of charging to a time of day when the first BEV travels the position of the charging station Cs5 (in this case, a time of day when the first BEV arrives at the facility A). When the charging station Cs5 of the facility A is not located within the range of the predetermined distance from the first point Pom, as in the above embodiment, a charging station closest from the first point Pom may be determined as the first charging station.

According to this modified example, the user of the internal combustion engine vehicle 10 can predict that the battery of the first BEV should be charged in the charging station Cs5 of the facility A when the battery of the first BEV needs charging on the assumption that the first BEV is operated according to the same operation schedule as the operation schedule of the internal combustion engine vehicle 10 during the first period.

### MODIFIED EXAMPLE 2

In the above embodiment, the example has been described in which, when there is more than one charging station within the predetermined distance from the first point Pom, a charging station among these charging stations that is closest from the first point Pom is determined as the first charging station. On the other hand, when there is more than one charging station within the predetermined distance from the first point Pom, a charging station that is free may be determined as the first charging station.

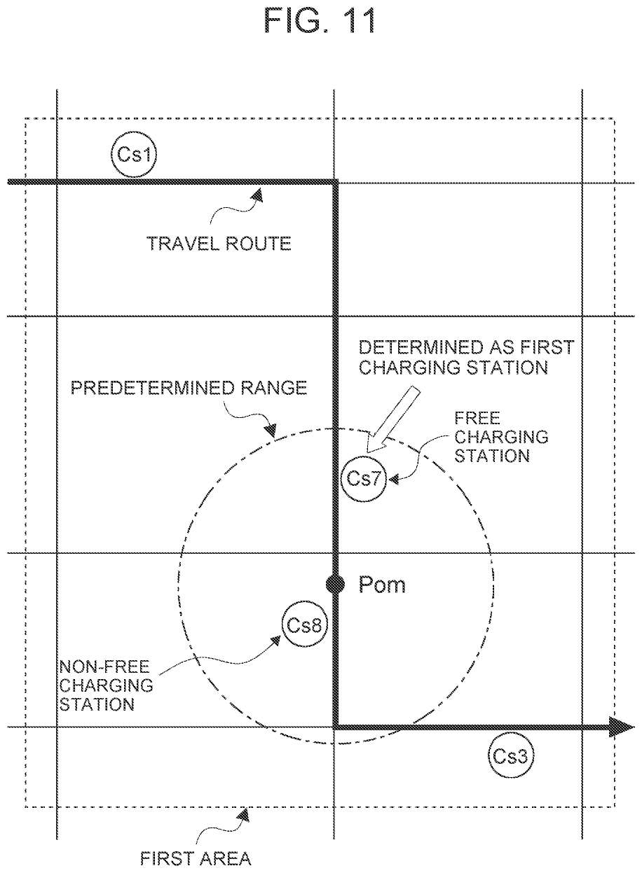

FIG. 11 is a view showing one example of the road map of the first area. In the example shown in FIG. 11, there are two charging stations within the range of the predetermined distance from the first point Pom (Cs7 and Cs8 in FIG. 11). Of these two charging stations Cs7 and Cs8, the charging station Cs7 can be used at no cost and the charging stand Cs8 can be used at cost. When there are such a free charging station Cs7 and a non-free charging station Cs8 within the range of the predetermined distance from the first point Pom, the simulation unit F320 of the server device 300 determines the free charging station Cs7 as the first charging station. When there is more than one free charging station within the range of the predetermined distance from the first point Pom, a charging station among these charging stations that is closest from the first point Pom may be determined as the first charging station. When all the charging stations located within the range of the predetermined distance from the first point Pom are non-free charging stations, a charging station among these charging stations that is closest from the first point Pom may be determined as the first charging station. In the example shown in FIG. 11, as in the example shown in FIG. 8 described above, the charging station Cs7 determined as the first charging station is located on a route that the first BEV travels before the first point Pom. Therefore, the simulation unit F320 may correct the timing of charging to a time of day when the first BEV travels the position of the charging station Cs7.

Information about whether each charging station is free or not free may be stored in the map information database D310 along with the information for locating the position of each charging station on the map, or may be stored in a database separate from the map information database D310.

According to this modified example, the user of the internal combustion engine vehicle 10 can ascertain that the battery of the first BEV can be charged in the free charging station Cs7 when the battery of the first BEV needs charging on the assumption that the first BEV is operated according to the same operation schedule as the operation schedule of the internal combustion engine vehicle 10 during the first period.

### MODIFIED EXAMPLE 3

In the above embodiment, the example has been described in which, when there is more than one charging station within the predetermined distance from the first point Pom, a charging station among these charging stations that is closest from the first point Pom is determined as the first charging station. On the other hand, when there is more than one charging station within the predetermined distance from the first point Pom, a charging station among these charging stations that is least crowded around a time of day when the timing of charging comes may be determined as the first charging station. In this case, statistics of the availability rate of each charging station by time of day may be obtained beforehand, and these statistics may be stored in the auxiliary storage unit 303 of the server device 300 by charging station.

According to this modified example, the user of the internal combustion engine vehicle 10 can ascertain a charging station that is least crowded around the time of day when the battery of the first BEV needs charging on the assumption that the first BEV is operated according to the same operation schedule as the operation schedule of the internal combustion engine vehicle 10 during the first period.

### MODIFIED EXAMPLE 4

In the above embodiment, the example has been described in which, when there is more than one charging station within the predetermined distance from the first point Pom, the charging station among these charging stations that is closest from the first point Pom is determined as the first charging station. On the other hand, when there is more than one charging station within the predetermined distance from the first point Pom, a charging station among these charging stations that is equipped with a quick charger may be determined as the first charging station.

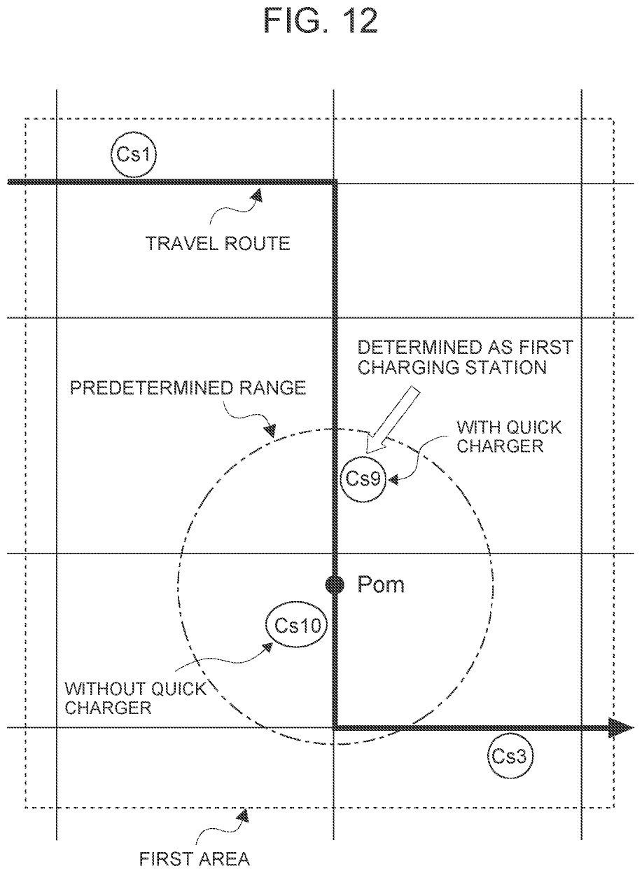

FIG. 12 is a view showing one example of the road map of the first area. In the example shown in FIG. 12, there are two charging stations within the range of the predetermined distance from the first point Pom (Cs9 and Cs10 in FIG. 12). Of these two charging stations Cs9 and Cs10, the charging station Cs9 is equipped with a quick charger but the charging station Cs10 is not equipped with a quick charger. When there are such a charging station Cs9 equipped with a quick charger and such a charging station Cs10 not equipped with a quick charger within the range of the predetermined distance from the first point Pom, the simulation unit F320 of the server device 300 determines the charging station Cs9 equipped with a quick charger as the first charging station. In the example shown in FIG. 12, as in the example shown in FIG. 8 described above, the charging station Cs9 determined as the first charging station is located on a route that the first BEV travels before the first point Porn. Therefore, the simulation unit F320 may correct the timing of charging to a time of day when the first BEV travels the position of the charging station Cs9. When there is more than one charging station equipped with a quick charger within the range of the predetermined distance from the first point Porn, a charging station among these charging stations that is closest from the first point Porn may be determined as the first charging station. When all the charging stations located within the range of the predetermined distance from the first point Porn are charging stations not equipped with a quick charger, a charging station closest from the first point Porn may be determined as the first charging station.

According to this modified example, the user of the internal combustion engine vehicle 10 can ascertain that the battery of the first BEV can be charged in the charging station Cs9 equipped with a quick charger when the battery of the first BEV needs charging on the assumption that the first BEV is operated according to the same operation schedule as the operation schedule of the internal combustion engine vehicle 10 during the first period.

### MODIFIED EXAMPLE 5

In the above embodiment, the example has been described in which, when it is determined that the battery needs charging during travel of the first BEV on the assumption that the first BEV is operated according to the virtual schedule, the user of the internal combustion engine vehicle 10 is provided with the first information including information showing the virtual schedule, information showing the simulation result, information showing that the battery needs charging during travel of the first BEV, information showing the timing of charging, and information on the position of the first charging station. On the other hand, when it is determined that the battery needs charging during travel of the first BEV on the assumption that the first BEV is operated according to the virtual schedule, the user of the internal combustion engine vehicle 10 may be provided with first information including information showing a charging time at the first charging station in addition to the aforementioned pieces of information.

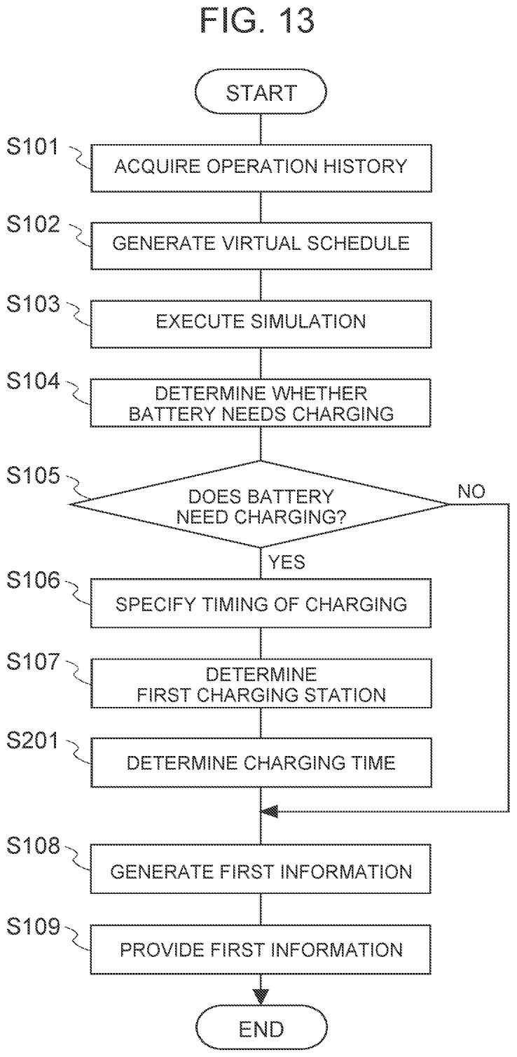

Here, the flow of processing executed in the server device 300 in this modified example will be described based on FIG. 13. FIG. 13 is a flowchart showing a processing routine that is executed in the server device 300 as the reception of an operation history from the user terminal 200 acts as a trigger. In FIG. 13, the same processes as in FIG. 9 described above are denoted by the same reference signs.

The processing routine of FIG. 13 differs from the processing routine of FIG. 9 in that the process of step S201 is executed after the process of step S107 is executed and before the process of step S108 is executed.

In step S201, the simulation unit F320 determines a charging time. The charging time here is a recommended charging time in the first charging station determined in step S107. To determine the charging time, the simulation unit F320 first obtains the length of the distance of a section of the travel route determined in the virtual schedule that is the section the first BEV travels after the battery is charged in the first charging station (hereinafter also referred to as a “first length of distance”). The simulation unit F320 obtains the remaining battery charge required for the first BEV to cover the first length of distance (hereinafter also referred to as a “target remaining battery charge”). The target remaining battery charge is calculated based on the power consumption rate of the first BEV and the first length of distance. The simulation unit F320 obtains the battery charging amount per unit time in the first charging station. The battery charging amount per unit time in the first charging station is determined according to the type, the rating, etc. of the charger installed in the first charging station. The simulation unit F320 calculates the charging time based on the target remaining battery charge and the battery charging amount per unit time in the first charging station. For example, the simulation unit F320 calculates the charging time by dividing the target remaining battery charge by the battery charging amount per unit time in the first charging station. The charging time thus obtained corresponds to the “third length of time” according to this disclosure.

When the simulation unit F320 has executed the process of step S201, the virtual schedule generated in step S102, the result of the simulation executed in step S103, the determination result of step S105, the timing of charging specified in step S106, the first charging station determined in step S107, and the charging time determined in step S201 are transferred from the simulation unit F320 to the generation unit F330.

The generation unit F330 executes the process of step S108 as the reception of the information from the simulation unit F320 acts as a trigger. In step S108 in this case, the generation unit F330 generates first information including information showing the virtual schedule, information showing the simulation result, information showing that the battery needs charging during travel of the first BEV, information showing the timing of charging, information on the position of the first charging station, and information showing the charging time in the first charging station. The first information generated by the generation unit F330 is transferred from the generation unit F330 to the provision unit F340.

The provision unit F340 executes the process of step S109 as the reception of the first information acts as a trigger. In step S109 in this case, the provision unit F340 provides the user with the first information including the information showing the virtual schedule, the information showing the simulation result, the information showing that the battery needs charging during travel of the first BEV, the information showing the timing of charging, the information on the position of the first charging station, and the information showing the charging time in the first charging station.

According to this modified example, the user of the internal combustion engine vehicle 10 can get a rough estimate about the charging time in the first charging station when the battery of the first BEV needs charging on the assumption that the first BEV is operated according to the same operation schedule as the operation schedule of the internal combustion engine vehicle 10 during the first period.

Others

The embodiment and the modified examples described above are merely examples, and this disclosure can be implemented with changes made thereto as necessary within the scope of the gist of the disclosure. For example, some or all of the processes executed in the server device 300 may be executed in the on-board terminal 100 or the user terminal 200. The information processing device according to this disclosure can also be applied to a terminal that is installed at a dealer selling the first BEV or other such place, or to a terminal carried by an employee of the dealer. In this case, the employee of the dealer may connect the terminal and the on-board terminal 100 to each other by a cable and retrieve an operation history from the on-board terminal 100 to the terminal.

The processes and means described in this embodiment can be implemented in arbitrary combinations to such an extent that no technical inconsistency arises. For example, the embodiment and Modified Examples 1 and 2 can be implemented in combination as far as possible. Further, processes having been described as being performed by one device may be shared and executed by a plurality of devices. Or processes having been described as being performed by different devices may be executed by one device. In the computer system, what hardware configuration to use to realize each function can be flexibly changed.

This disclosure can also be realized by supplying a computer program having the functions described in the above embodiment to a computer and making one or more processors belonging to the computer retrieve and execute this program. Such a computer program may be provided to the computer by a non-transitory computer-readable recording medium that can be connected to a system bus of the computer, or may be provided to the computer through a network. A non-transitory computer-readable recording medium is a recording medium that accumulates pieces of information, such as data and programs, by electrical, magnetic, optical, mechanical, or chemical action and can be read by a computer or the like. Examples of such recording media can be arbitrary types of discs including magnetic discs (floppy (R) discs and HDDs) and optical discs (CD-ROMs, DVDs, and Blu-ray Discs). In addition, the recording medium may be a medium such as an ROM, an RAM, an EPROM, an EEPROM, a magnetic card, a flash memory, an optical card, or a solid state drive (SSD).

What is claimed is:

1. An information processing device comprising a control unit that executes:
acquiring an operation history of an internal combustion engine vehicle for a first period;
generating first information about a timing of charging a battery of a first battery electric vehicle on an assumption that the first battery electric vehicle is operated according to an operation schedule shown by the operation history; and
outputting the first information through a first terminal.

2. The information processing device according to claim 1, wherein the control unit executes:
calculating a battery consumption amount of the first battery electric vehicle on the assumption that the first battery electric vehicle is operated according to the operation schedule shown by the operation history;
calculating a remaining battery charge of the first battery electric vehicle based on the battery consumption amount;
determining the timing of charging based on the remaining battery charge; and
generating the first information based on the timing of charging.

3. The information processing device according to claim 2, wherein:
the control unit further executes:
specifying a first length of time for which the first battery electric vehicle is parked in a storage place on the assumption that the first battery electric vehicle is operated according to the operation schedule shown by the operation history; and
calculating a first charging amount of the battery on an assumption that the first length of time is a length of a charging time of the battery; and
the control unit calculates the remaining battery charge based on the first charging amount in addition to the battery consumption amount.

4. The information processing device according to claim 3, wherein:
the control unit further executes:
specifying a first place that is a place other than the storage place and includes a charging station among places where the first battery electric vehicle is parked on the assumption that the first battery electric vehicle is operated according to the operation schedule shown by the operation history;
specifying a second length of time for which the first battery electric vehicle is parked in the first place on the assumption that the first battery electric vehicle is operated according to the operation schedule shown by the operation history; and
calculating a second charging amount of the battery on an assumption that the second length of time is a length of a charging time of the battery; and
the control unit calculates the remaining battery charge based on the second charging amount in addition to the battery consumption amount and the first charging amount.

5. The information processing device according to claim 2, wherein:
the first information further includes information about a first charging station that is a charging station suitable to charge the battery; and
the control unit further executes:
specifying a travel route of the first battery electric vehicle on the assumption that the first battery electric vehicle is operated according to the operation schedule shown by the operation history;
specifying a point on the travel route at which the timing of charging comes; and
determining, as the first charging station, a charging station that is located on the travel route within a predetermined distance from the point at which the timing of charging comes.

6. The information processing device according to claim 5, wherein the control unit determines, as the first charging station, a charging station that is located on the travel route within the predetermined distance from the point at which the timing of charging comes, and that is installed in a place where the first battery electric vehicle is parked on the assumption that the first battery electric vehicle is operated according to the operation schedule shown by the operation history.

7. The information processing device according to claim 5, wherein the control unit determines, as the first charging station, a charging station that is located on the travel route within the predetermined distance from the point at which the timing of charging comes and that is free.

8. The information processing device according to claim 5, wherein the control unit determines, as the first charging station, a charging station that is located on the travel route within the predetermined distance from the point at which the timing of charging comes and that is least crowded around a time of day when the timing of charging comes.

9. The information processing device according to claim 5, wherein the control unit determines, as the first charging station, a charging station that is located on the travel route within the predetermined distance from the point at which the timing of charging comes and that is equipped with a quick charger.

10. The information processing device according to claim 5, wherein:
the first information includes information about a third length of time that is a length of a recommended charging time at the first charging station, in addition to information about the timing of charging the battery on the assumption that the first battery electric vehicle is operated according to the operation schedule shown by the operation history and information about the first charging station; and
the control unit further executes:
calculating a remaining battery charge at a point in time when the first battery electric vehicle arrives at the first charging station; and
calculating the third length of time based on the remaining battery charge.

11. An information processing method in which a computer executes:
acquiring an operation history of an internal combustion engine vehicle for a first period;
generating first information about a timing of charging a battery on an assumption that a first battery electric vehicle is operated according to an operation schedule shown by the operation history; and
outputting the first information through a first terminal.

12. The information processing method according to claim 11, wherein the computer executes:
calculating a battery consumption amount on the assumption that the first battery electric vehicle is operated according to the operation schedule shown by the operation history;
calculating a remaining battery charge based on the battery consumption amount;
determining the timing of charging based on the remaining battery charge; and
generating the first information based on the timing of charging.

13. The information processing method according to claim 12, wherein:
the computer further executes:
specifying a first length of time for which the first battery electric vehicle is parked in a storage place on the assumption that the first battery electric vehicle is operated according to the operation schedule shown by the operation history; and
calculating a first charging amount of the battery on an assumption that the first length of time is a length of a charging time of the battery; and
the computer calculates the remaining battery charge based on the first charging amount in addition to the battery consumption amount.

14. The information processing method according to claim 13, wherein:
the computer further executes:
specifying a first place that is a place other than the storage place and includes a charging station among places where the first battery electric vehicle is parked on the assumption that the first battery electric vehicle is operated according to the operation schedule shown by the operation history;
specifying a second length of time for which the first battery electric vehicle is parked in the first place on the assumption that the first battery electric vehicle is operated according to the operation schedule shown by the operation history; and
calculating a second charging amount of the battery on an assumption that the second length of time is a length of a charging time of the battery; and
the computer calculates the remaining battery charge based on the second charging amount in addition to the battery consumption amount and the first charging amount.

15. The information processing method according to claim 12, wherein:
the first information further includes information about a first charging station that is a charging station suitable to charge the battery; and
the computer further executes:
specifying a travel route of the first battery electric vehicle on the assumption that the first battery electric vehicle is operated according to the operation schedule shown by the operation history;
specifying a point on the travel route at which the timing of charging comes; and
determining, as the first charging station, a charging station that is located on the travel route within a predetermined distance from the point at which the timing of charging comes.

16. The information processing method according to claim 15, wherein the computer determines, as the first charging station, a charging station that is located on the travel route within the predetermined distance from the point at which the timing of charging comes, and that is installed in a place where the first battery electric vehicle is parked on the assumption that the first battery electric vehicle is operated according to the operation schedule shown by the operation history.

17. The information processing method according to claim 15, wherein the computer determines, as the first charging station, a charging station that is located on the travel route within the predetermined distance from the point at which the timing of charging comes and that is free.

18. The information processing method according to claim 15, wherein the computer determines, as the first charging station, a charging station that is located on the travel route within the predetermined distance from the point at which the timing of charging comes and that is least crowded around a time of day when the timing of charging comes.

19. The information processing method according to claim 15, wherein the computer determines, as the first charging station, a charging station that is located on the travel route within the predetermined distance from the point at which the timing of charging comes and that is equipped with a quick charger.

20. The information processing method according to claim 15, wherein:
the first information includes information about a third length of time that is a length of a recommended charging time at the first charging station, in addition to information about the timing of charging the battery on the assumption that the first battery electric vehicle is operated according to the operation schedule shown by the operation history and information about the first charging station; and
the computer further executes:
calculating a remaining battery charge at a point in time when the first battery electric vehicle arrives at the first charging station; and
calculating the third length of time based on the remaining battery charge.
